(19) United States
(12) Patent Application Publication
(10) Pub. No.: US 2014/0144591 A1
(43) Pub. Date: May 29, 2014

(54) METHOD FOR SEPARATION OF RUBBER FROM METAL

(71) Applicant: Roman N. Pozdnyakov, Westfield, MA (US)

(72) Inventor: Roman N. Pozdnyakov, Westfield, MA (US)

(21) Appl. No.: 13/772,167

(22) Filed: Feb. 20, 2013

Related U.S. Application Data
(60) Provisional application No. 61/731,457, filed on Nov. 29, 2012.

(51) Int. Cl. B32B 43/00

(52) U.S. Cl. CPC B32B 43/006
USPC 156/703

(57) ABSTRACT

A method for separating metal-rubber bonded parts can save money, time, ecology and doesn't change the quality and structure of the metal. The method uses heated oil to easily separate rubber from metal parts without damaging the part or requiring restoration thereof.

### CROSS-REFERENCE TO RELATED APPLICATION

This application claims the benefit of priority of U.S. provisional application No. 61/731,457, filed Nov. 29, 2012, the contents of which are herein incorporated by reference.

### BACKGROUND OF THE INVENTION

The present invention relates to component separation techniques and, more particularly, to a method for the separation of rubber from metal using heated oil.

Expensive metal-rubber bonded parts often need restoration. Conventional systems for the separation of rubber from metal parts often use complicated equipment, take substantial time, and can use chemicals harmful to the environment. These systems can also create defects on the metal parts, potentially ruining the parts or requiring separate restoration of the original metal part.

As can be seen, there is a need for an improved method for the separation of rubber from metal parts.

### SUMMARY OF THE INVENTION

In one aspect of the present invention, a method for separating rubber from metal comprises heating oil to a desired temperature; disposing a part having rubber bonded or fused to metal to be separated into the oil for a predetermined period of time; removing the part from the oil; and separating the rubber from the metal of the part.

In another aspect of the present invention, a method for separating rubber from metal comprising heating oil to a desired temperature from about 250° C. to about 275° C.; disposing a part having rubber bonded or fused to metal to be separated into the heated oil for a predetermined period of time from about 20 to about 30 minutes; removing the part from the oil; and separating the rubber from the metal of the part without damaging the metal of the part.

These and other features, aspects and advantages of the present invention will become better understood with reference to the following drawings, description and claims.

### BRIEF DESCRIPTION OF THE DRAWINGS

FIG. 1 is a schematic elevation view depicting the components used in the process according to an exemplary embodiment of the present invention;

FIG. 2 is a perspective view of a typical component treated by methods of the present invention;

FIG. 3 is a schematic view showing an exemplary first step of the method of the present invention;

FIG. 4 is a schematic view showing an exemplary second step of the method of the present invention;

FIG. 5 is a schematic view showing an exemplary third step of the method of the present invention;

FIG. 6 is a schematic view showing an exemplary fourth step of the method of the present invention; and

FIG. 7 is a perspective view showing the typical part of FIG. 2 after treatment by the method of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method for separating metal-rubber bonded parts. The methods of the present invention can save money, time, ecology and doesn't change the quality and structure of the metal. The method uses heated oil to easily separate rubber from metal parts without damaging the part or requiring restoration thereof.

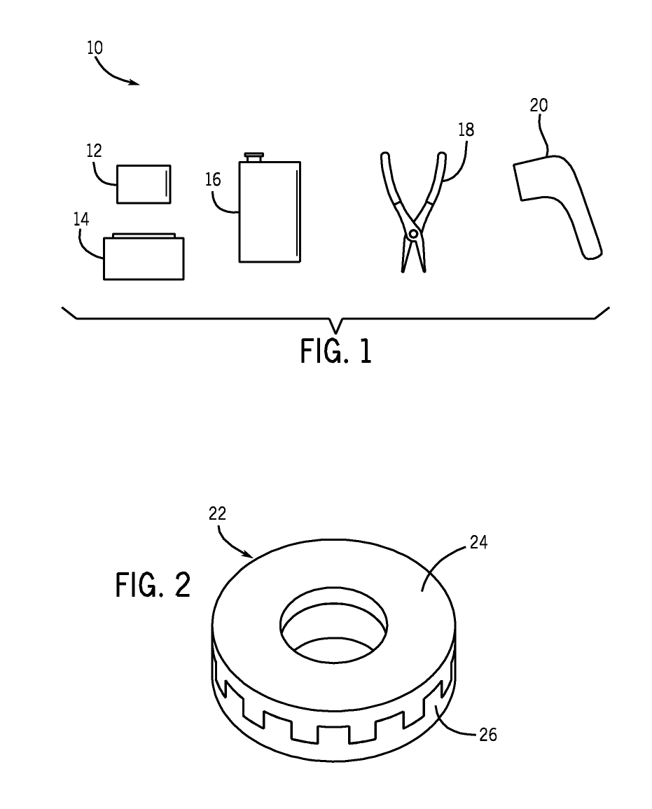

Referring now to FIGS. 1 through 7, an exemplary method of the present invention uses several components 10, as shown in FIG. 1. These components include a metal container 12, a heater 14, high temperature oil 16, a gripping and lifting device 18, and a thermometer 20, such as a precision infrared thermometer.

A part 22 to be treated, as shown in FIG. 2, can include a rubber component 24 and a metal component 26. These components 24, 26 may be bonded or fused together and can be difficult to separate during, for example, restoration or the metal components.

The metal container 12 can be sized appropriate to contain the part 22. The oil 16 can be a high temperature oil, such as Mobil® 600W super cylinder oil or other similar oil. The heater 14 can be, for example, an electrical hot plate operating at, for example 1500W, or at an appropriate power to heat the oil 16 as described below. The thermometer 20 can be a non-contact thermometer, such as a precision infrared thermometer with laser targeting. Typically, the thermometer 20 can measure temperatures up to at least 300° C.

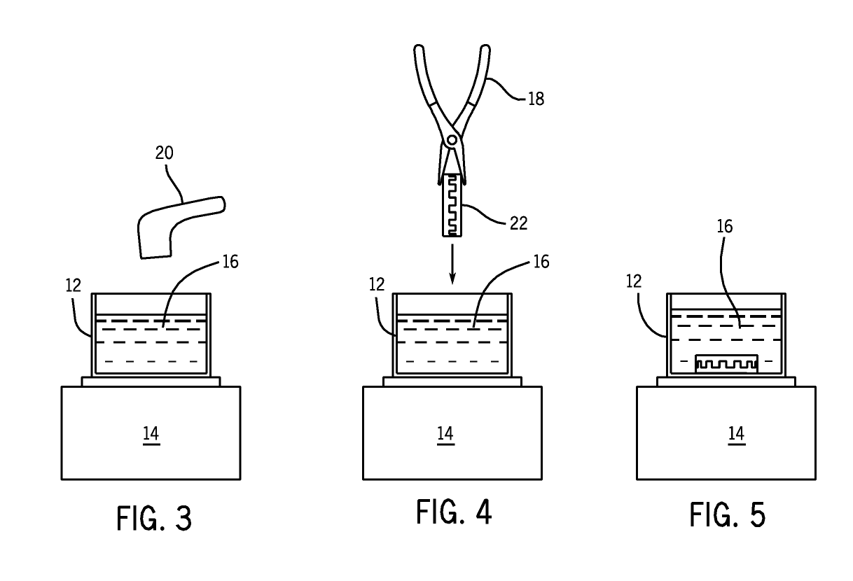

As shown in FIG. 3, the oil 16 can be placed in the container 12 and the container can be placed on the heater 14 to warm the oil 16. This temperature can vary depending on the application, but is typically about 250° C. to about 275° C., typically about 250° C. Once the desired temperature is reached, as shown in FIG. 4, the part 22 can be placed in the oil 16 using the gripping and lifting device 18.

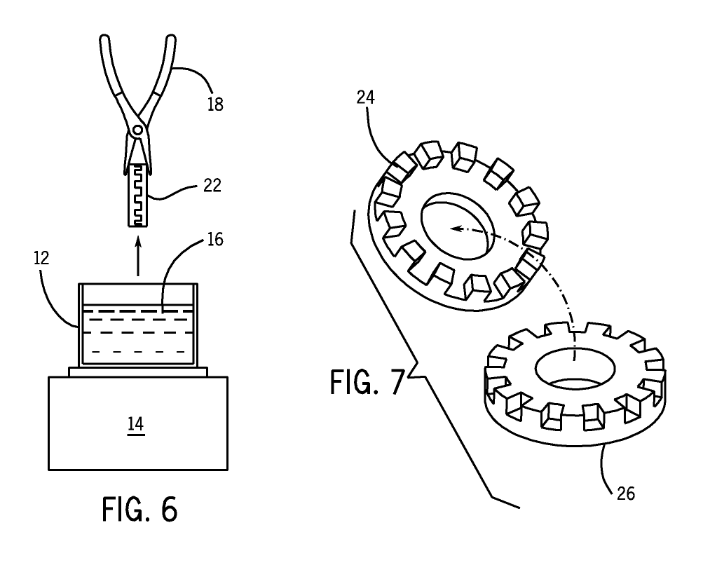

As shown in FIG. 5, the part 22 can stay in the heated oil 16 for a predetermined period of time, typically from about 20 to about 30 minutes. As shown in FIG. 6, the heater 14 can be turned off and the part 22 can be removed from the oil 16, typically using the gripping and lifting device 18. As this stage, the rubber component 22 should be easily removable from the metal component 24. Appropriate tools can be used to make this separation, resulting in separated components 22, 24, as shown in FIG. 7.

It should be understood, of course, that the foregoing relates to exemplary embodiments of the invention and that modifications may be made without departing from the spirit and scope of the invention as set forth in the following claims.

What is claimed is:

1. A method for separating rubber from metal, comprising:
heating oil to a desired temperature;
disposing a part having rubber bonded or fused to metal to be separated into the oil for a predetermined period of time;
removing the part from the oil; and
separating the rubber from the metal of the part.

2. The method of claim 1, further comprising heating the oil to a temperature from about 250° C. to about 275° C.

3. The method of claim 1, further comprising disposing the part into the oil for about 20 to about 30 minutes.

4. The method of claim 1, further comprising removing the part from the oil with a gripping and lifting device.

5. The method of claim 1, wherein the rubber is separated from the metal of the part without damaging the metal of the part.

6. The method of claim 1, wherein the oil is cylinder oil.

7. The method of claim 1, further comprising heating oil to the desired temperature on a hot plate prior to insertion of the part therein.

8. A method for separating rubber from metal, comprising:
heating oil to a desired temperature from about 250° C. to about 275° C.;
disposing a part having rubber bonded or fused to metal to be separated into the heated oil for a predetermined period of time from about 20 to about 30 minutes;
removing the part from the oil; and
separating the rubber from the metal of the part without damaging the metal of the part.

9. The method of claim 8, further comprising removing the part from the oil with a gripping and lifting device.

10. The method of claim 8, further comprising heating oil to the desired temperature on a hot plate prior to insertion of the part therein.
